(19) United States
(12) Patent Application Publication
(10) Pub. No.: US 2025/0077128 A1
(43) Pub. Date: Mar. 6, 2025

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: SHINYA SUZUKI, Chiba (JP)

(21) Appl. No.: 18/813,191

(22) Filed: Aug. 23, 2024

(30) Foreign Application Priority Data
Aug. 29, 2023 (JP) 2023-139125

(51) Int. Cl. G06F 3/12; H04N 1/00

(52) U.S. Cl. CPC G06F 3/1203; G06F 3/1267; G06F 3/1285; H04N 1/00212; H04N 1/00233

(57) ABSTRACT

The present disclosure is direct to an information processing apparatus comprising one or more memory devices that store a set of instructions; and one or more processors that execute the set of instructions to: manage files to be printed that are accessible from a plurality of apparatuses via a network, and make, in response to a request from any one of the plurality of apparatuses, a list of one or more of the files to be printed based on a first condition included in the request, and cause the one apparatus that has made the request to display the list, wherein the first condition is a condition selected from a plurality of conditions by a user operation in the one apparatus that has made the request.

### BACKGROUND OF THE INVENTION

### Field of the Invention

The present invention relates to an information processing apparatus, a control method thereof, and a storage medium.

### Description of the Related Art

In recent years, the number of scenes is increasing in which a business chat and a web meeting are used in the business operation. In accordance therewith, file sharing with other users is frequently performed by transmitting messages with attached files, or uploading files to be used in a web meeting to a cloud storage. In Japanese Patent Laid-Open No. 2021-124791, a mechanism is proposed that enables, with respect to files to which a plurality of users can refer through a service that provides a business chat function and a web meeting function, instructing printing from a screen provided by the service.

However, the known technology described above has a problem described below. For example, when a file uploaded using a chat function is to be printed, a user needs to search a message to which the file is attached by taking a glance at the chat screen again. Therefore, when files are shared between a plurality of users using a communication tool such as a chat function or a web meeting function, for example, there is a problem in that a user needs to take time and effort in order to select a file to be printed. Therefore, it is conceivable that, in order for a user to be able to easily select a file to be printed, a file list is displayed, and the user is allowed to select the file to be printed. However, when the method of listing files is limited to one listing method, it may be difficult to retrieve a desired file, depending on the user. For example, when only “recently-used file” is provided as the listing method, a situation may arise in which a user cannot find a file that the user desires to print, and cannot select the file as a file to be printed.

### SUMMARY OF THE INVENTION

The present invention enables realization of a mechanism in which, in a system in which files are shared between a plurality of users, retrieving a desired file to be printed by a user is suitably assisted.

One aspect of the present invention provides an information processing apparatus comprising one or more memory devices that store a set of instructions; and one or more processors that execute the set of instructions to: manage files to be printed that are accessible from a plurality of apparatuses via a network, and make, in response to a request from any one of the plurality of apparatuses, a list of one or more of the files to be printed based on a first condition included in the request, and cause the one apparatus that has made the request to display the list, wherein the first condition is a condition selected from a plurality of conditions by a user operation in the one apparatus that has made the request.

Another aspect of the present invention provides a control method of an information processing apparatus, comprising: managing files to be printed that are accessible from a plurality of apparatuses via a network, and making, in response to a request from any one of the plurality of apparatuses, a list of one or more of the files to be printed based on a first condition included in the request, and causing the one apparatus that has made the request to display the list, wherein the first condition is a condition selected from a plurality of conditions by a user operation in the one apparatus that has made the request.

Still another aspect of the present invention provides a non-transitory computer-readable storage medium storing a computer program for causing a computer to execute the steps in a control method of an information processing apparatus, the control method comprising: managing files to be printed that are accessible from a plurality of apparatuses via a network, and making, in response to a request from any one of the plurality of apparatuses, a list of one or more of the files to be printed based on a first condition included in the request, and causing the one apparatus that has made the request to display the list, wherein the first condition is a condition selected from a plurality of conditions by a user operation in the one apparatus that has made the request.

Further features of the present invention will be apparent from the following description of exemplary embodiments with reference to the attached drawings.

### BRIEF DESCRIPTION OF THE DRAWINGS

FIG. 1 is a diagram illustrating a configuration of an information processing system according to one embodiment.

FIG. 2 is a diagram illustrating a hardware configuration of a computer and a printer according to one embodiment.

FIG. 3 is a diagram illustrating a functional configuration of the information processing system according to one embodiment.

FIG. 4 is a diagram illustrating an example of a chat screen of a business chat service according to one embodiment.

FIG. 5 is a diagram illustrating an example of a file information database according to one embodiment.

FIGS. 6A-6B are a flowchart showing processing of a web server 302 according to one embodiment.

FIG. 7 is a diagram illustrating a first display mode of a business chat service screen according to one embodiment.

FIG. 8 is a diagram illustrating a second display mode of the business chat service screen according to one embodiment.

FIG. 9 is a flowchart in which, in the second display mode of the business chat service screen according to one embodiment, filtering processing is added.

FIG. 10 is a flowchart in which, in the second display mode of the business chat service screen according to one embodiment, a filtering item is added.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <System Configuration>

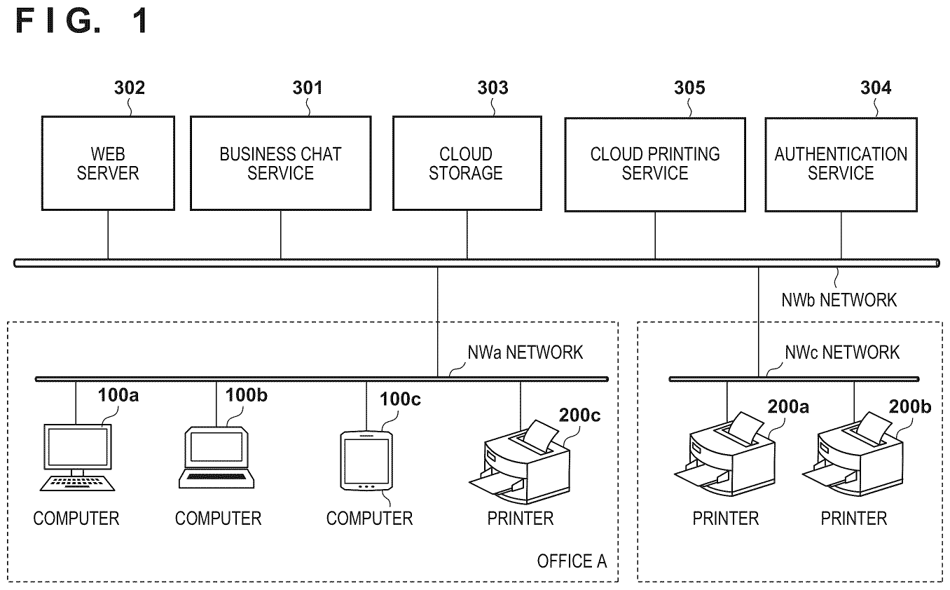

One embodiment of the present invention will be described below. First, an exemplary configuration of an information processing system according to the present embodiment will be described with reference to FIG. 1. In FIG. 1, the information processing system includes computers 100a to 100c and printers 200a to 200c. Also, in FIG. 1, the information processing system includes a business chat service 301, a web server 302, a cloud storage 303, an authentication service 304, a cloud printing service 305, and networks NWa to NWc.

In FIG. 1, a case is illustrated in which the computers 100a to 100c that create documents and images to be printed and the printer 200c are connected to the network NWa in an office A. Note that the computers 100a to 100c and the printer 200c may also be connected to each other such that communication is possible via a plurality of networks. Also, the printer 200c may also be connected to the computers 100a to 100c via a universal serial bus (USB). Also, as shown in FIG. 1, in this information processing system, the business chat service 301, the web server 302, the cloud storage 303, the authentication service 304, and the cloud printing service 305 are connected via the network NWb. Moreover, the printers 200a and 200b are connected to the network NWc, which is different from the networks NWa and NWb. The computers 100a to 100c are each one example of the information processing apparatus, and the printers 200a to 200c are each one example of an image forming apparatus.

The computers 100a to 100c can communicate with the business chat service 301, the web server 302, the cloud storage 303, the authentication service 304, and the cloud printing service 305 via the networks NWa and NWb. Also, the computers 100a to 100c can communicate with the printers 200a and 200b via the networks NWa to NWc. The networks NWa to NWc may each be a small-scale network or a large-scale network. For example, the networks NWa to NWc may each be a personal area network (PAN), a local area network (LAN), or another network. Also, the configuration of the network (the number and scale of the networks) is not limited to the configuration shown in FIG. 1 as long as each device can communicate with the other devices. A configuration may also be adopted in which each device can communicate with the other devices via the Internet. Also, the information processing system may also be constructed using a cloud. There is no limitation to the communication method, and communication through a wireless LAN conforming to the IEEE 802.11 standard may be used, for example. Also, communication through a mobile phone network conforming to the Bluetooth (registered trademark) communication or the International Mobile Telecommunication-2000 (IMT-2000) standard may also be used. Also, the connection mode between devices that use USB may be in a mode in which the devices are directly connected to each other, or in a mode in which the devices are connected by a device such as a USB hub or switching equipment relaying the communication.

Also, the number of computers 100a to 100c and the number of the printers 200a to 200c are not limited. In the present embodiment, a case is illustrated in which the computers 100a to 100c have the same configuration. However, the configurations of the computers 100a to 100c may not be the same. In the following description, when the computer may be any one of the computers 100a to 100c, the computers 100a to 100c may be referred to as computers 100, as needed. Similarly, in the present embodiment, a case is illustrated in which the printers 200a to 200c have the same configuration. However, the configurations of the printers 200a to 200c may not be the same. In the following description, when the printer may be any one of the printers 200a to 200c, the printers 200a to 200c may be referred to as printers 200, as needed. Also, when the network may be any one of the networks NWa to NWc, the networks NWa to NWc may be referred to as networks NW, as needed.

### <Apparatus Hardware Configuration>

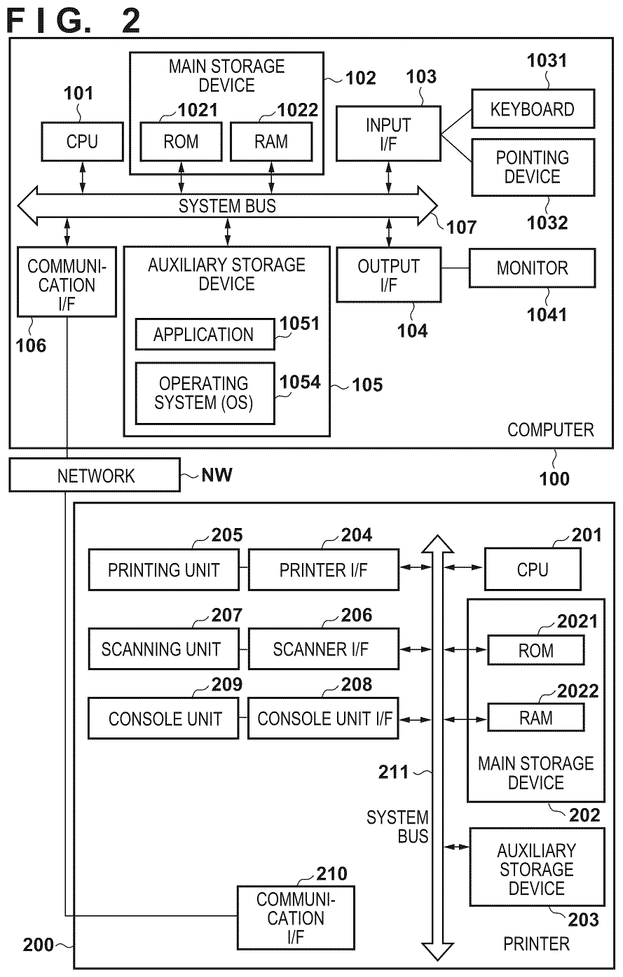

Next, an example of the hardware configuration of the computers 100 and printers 200 according to the present embodiment will be described with reference to FIG. 2. Note that the hardware configuration of each of the business chat service 301, web server 302, cloud storage 303, authentication service 304, and cloud printing service 305 may be realized with the configuration similar to the computers 100 described below, for example. Therefore, detailed descriptions of the hardware configurations of the business chat service 301, web server 302, cloud storage 303, authentication service 304, and cloud printing service 305 are omitted here. Note that the hardware configurations of the business chat service 301, web server 302, cloud storage 303, authentication service 304, and cloud printing service 305 may also be different to each other. Also, a function that at least one of the business chat service 301, web server 302, cloud storage 303, authentication service 304, and cloud printing service 305 has may be realized by combining a plurality of apparatuses. Also, a function that at least two of the business chat service 301, web server 302, cloud storage 303, authentication service 304, and cloud printing service 305 have may be realized by one apparatus.

First, an exemplary configuration of each computer 100, which is an example of the information processing apparatus, will be described. The computer 100 include a central processing unit (CPU) 101, a main storage device 102, and an auxiliary storage device 105. Also, the main storage device 102 includes a read only memory (ROM) 1021 and a random access memory (RAM) 1022. The CPU 101 performs overall control on the computer 100 according to a program stored in the main storage device 102 or the auxiliary storage device 105. The RAM 1022 may also be used as a work area when the CPU 101 performs each process. Note that the computer 100 may also include a processor (e.g., graphics processing unit (GPU)) other than the CPU. Various types of programs such as a plug-in (application) 1051 and an operating system (OS) 1054 are stored in the auxiliary storage device 105. The auxiliary storage device 105 may be realized by using a hard disk drive (HDD) or a solid state drive (SSD), for example.

The computer 100 includes an input interface (I/F) 103, a keyboard 1031, and a pointing device 1032. The pointing device 1032 includes a mouse, a touch panel, and a touch pad, for example. The keyboard 1031 and the pointing device 1032 are examples of the input device for a user to perform an input operation to the computer 100. The input device may also include a device in addition to the keyboard 1031 and the pointing device 1032. The input devices such as the keyboard 1031 and pointing device 1032 are connected to the computer 100 via the input I/F 103. The computer 100 receives a user operation on a program via these input devices.

The computer 100 includes an output I/F 104 and a monitor 1041. An output device such as the monitor 1041 is connected to the output I/F 104. The computer 100 displays various types of information on the monitor 1041 according to an instruction of a program. The computer 100 can display a graphical user interface (GUI) on the monitor 1041. Note that, in FIG. 2, the pointing device 1032 and the monitor 1041 are shown as devices separated by roles. However, there are terminals, represented by a smartphone and a tablet terminal, in which the pointing device 1032 and the monitor 1041 are integrated. In such terminals, the pointing device 1032 and the monitor 1041 may also be integrated.

The computer 100 includes a communication I/F 106. The communication I/F 106 is connected to the network NW. The computer 100 can communicate with an external apparatus via the communication I/F 106. The modules, namely the CPU 101, the main storage device 102, the input I/F 103, the output I/F 104, the auxiliary storage device 105, and the communication I/F 106, can transmit and receive data via a system bus 107.

The application 1051 and OS 1054 include programs and the like for executing processing described in the present embodiment. The application 1051 and OS 1054 may be added to the auxiliary storage device 105 via an unshown storage medium (e.g., CD-ROM or USB memory). Also, the application 1051 and OS 1054 may be added to the auxiliary storage device 105 via the network NW.

Next, the exemplary hardware configuration of each printer 200, which is an example of the image forming apparatus will be described. Here, the case where the printer 200 is a multi-function peripheral is illustrated. However, the printer 200 is not limited to a multi-function peripheral. For example, the printer 200 may also be a printer that does not have a scanner function.

The printer 200 includes a CPU 201, a main storage device 202, and an auxiliary storage device 203. Also, the main storage device 202 includes a ROM 2021 and a RAM 2022. The CPU 201 performs overall control on the printer 200 according to a program stored in the main storage device 202 or the auxiliary storage device 203. The RAM 2022 may also be used as a work area when the CPU 201 performs each process. Note that the printer 200 may also include a processor (e.g., GPU) other than the CPU. Various types of data such as print data and a scan image are stored in the auxiliary storage device 203. The auxiliary storage device 203 may be realized by using an HDD or an SSD, for example.

The printer 200 includes a printer I/F 204, a printing unit 205, a scanner I/F 206, a scanning unit 207, a console unit I/F 208, a console unit 209, and a communication I/F 210. The printing unit 205 is connected to the printer I/F 204. The printing unit 205 executes print processing based on print data received from an external apparatus (e.g., computer 100), a scan image generated by the scanning unit 207, or the like. The scanning unit 207 is connected to the scanner I/F 206. The scanning unit 207 generates a scan image by optically reading a document. The scan image generated by the scanning unit 207 may be printed by the printing unit 205, or stored in the auxiliary storage device 203.

The console unit 209 is connected to the console unit I/F 208. The console unit 209 includes a display unit having a touch panel function (e.g., liquid-crystal display unit) and a keyboard. The console unit 209 displays various types of operation screens. A user inputs an instruction or information to the printer 200 through the console unit 209. The console unit 209 receives an instruction or information input by the user. The communication I/F 210 is connected to the network NW. The printer 200 can communicate with an external apparatus via the communication I/F 210. The modules, namely the CPU 201, the main storage device 202, the auxiliary storage device 203, the printer I/F 204, the scanner I/F 206, the console unit I/F 208, and the communication I/F 210, can transmit and receive data via a system bus 211.

Note that the device configurations are not limited to the configurations described above, as long as the functions of the information processing system described in the present embodiment can be executed, unless otherwise stated. For example, the information processing system of the present embodiment may be a single device, a system constituted by a plurality of devices, or a system in which connection is made via a local network, and processing is performed.

### <Functional Configuration>

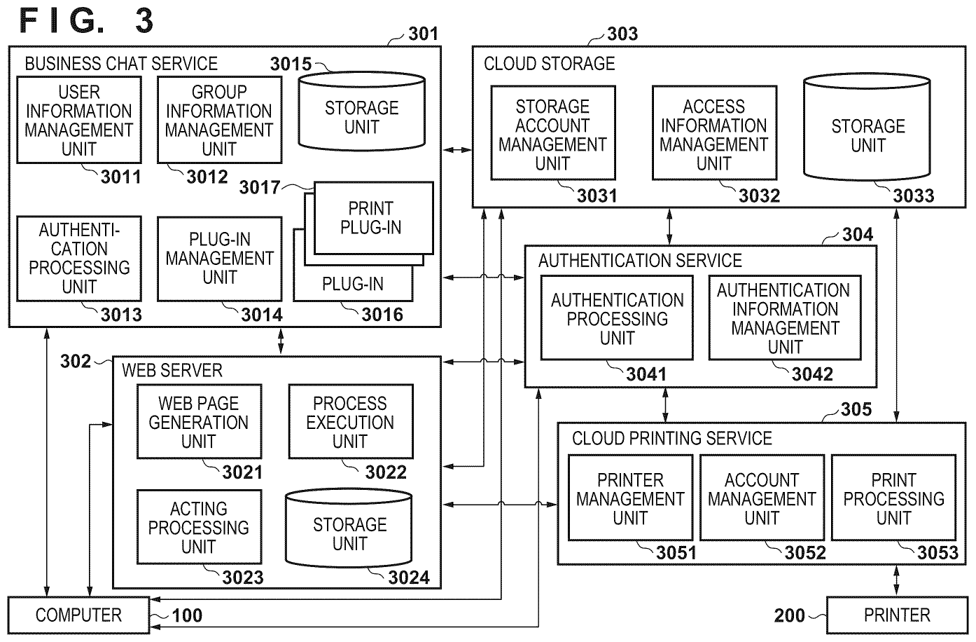

Next, an exemplary functional configuration of the information processing system according to the present embodiment will be described with reference to FIG. 3. In the present embodiment, main functions will be illustrated envisioning a case where printing is performed in the printer 200 using a “plug-in” managed by the business chat service 301. The “plug-in” indicates a module for additionally extending another function to an application. In the present embodiment, a module (print plug-in 3017) for extending a printing function with respect to the business chat service 301 is indicated.

A user accesses the business chat service 301 by operating his/her computer 100. In the business chat service 301, chats between users, a web meeting, and a file management are performed. Note that, in the present embodiment, it is premised on that the print plug-in 3017 provides a printing function regarding a file managed by the business chat service 301. Also, the service provided by the business chat service 301 may be executed on a web browser as a web plug-in, or may operate on the application 1051.

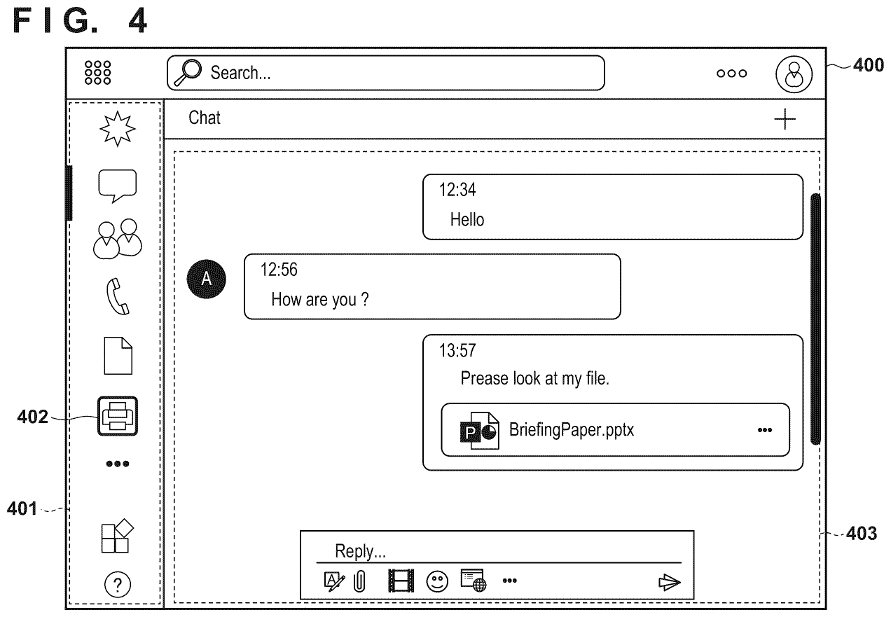

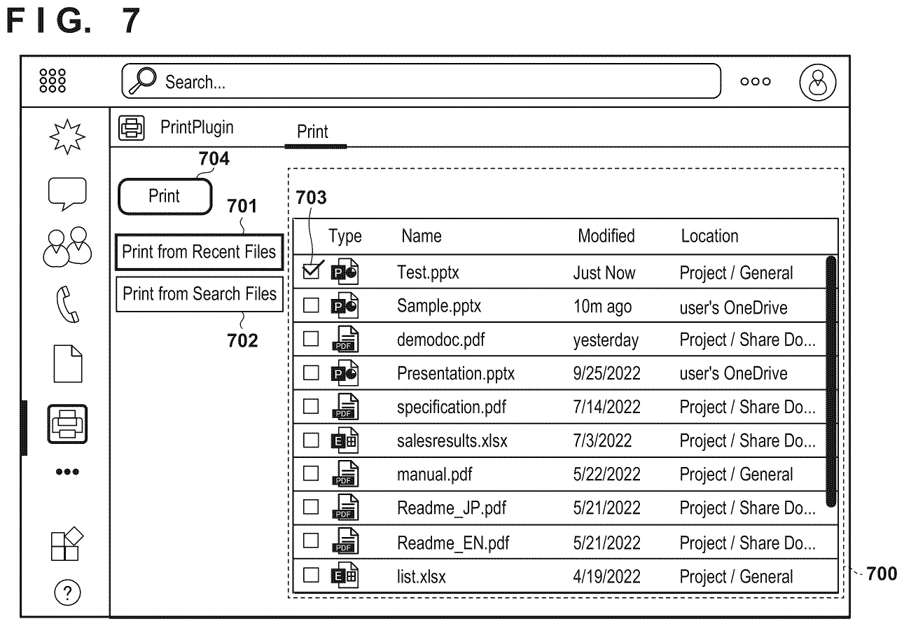

Here, a screen displayed to a user in the business chat service 301 will be described with reference to FIG. 4. FIG. 4 shows an example of a screen 400 of the business chat service 301. The screen 400 shows a situation in which a screen displayed when a user chats with another user is displayed on the monitor 1041 of the computer 100, for example. A portion that shows various functions and is present on the left end of the screen is referred to as a function arrangement area 401, and a function can be called from the business chat service 301. For example, when the print plug-in 3017 is installed, and is incorporated in the business chat service 301, a button 402 for starting the print plug-in 3017 can be displayed in the function arrangement area 401, as shown in FIG. 4. In the present embodiment, a case is illustrated where, as a result of a user operating the button 402 for starting the print plug-in 3017 in the function arrangement area 401, a unique screen is displayed in a content area 403, and the user performs an operation to perform printing using the screen. In the present embodiment, it is assumed that when the button 402 for starting the print plug-in 3017 is operated, the content area 403 is updated and switched to a screen for selecting a file to be printed, as shown in FIG. 7. Note that the screen for selecting a file to be printed may also be opened in a window different from the window before transitioning to the screen for selecting a file to be printed.

### (Functional Configuration of Business Chat Service)

Returning to the description of FIG. 3, the functional configuration of the business chat service 301 will be described. The business chat service 301 includes a user information management unit 3011, a group information management unit 3012, an authentication processing unit 3013, a plug-in management unit 3014, a storage unit 3015, and a plug-in group 3016. A web service provided by the web server 302, the cloud storage 303, and the like that cooperate with the business chat service 301 may be performed using a function incorporated in the business chat service 301, or may also be performed in cooperation with external completely different service. The user information management unit 3011 is a module for managing information regarding users that use the business chat service 301. The information regarding a user includes information regarding chats that the user performed, information regarding plug-ins that the user can use, and information regarding files that a group to which the user belongs and the user can access, for example.

The group information management unit 3012 is a module for managing information regarding, in a cluster called a group constituted by any users, chats performed in the group and files that the group has. Also, the group information management unit 3012 may perform management of data associated with the group such as a memorandum or recorded data of a meeting held in the group.

The authentication processing unit 3013 is a module for performing processing, in cooperation with the authentication service 304, regarding authentication of users that use the business chat service 301. For example, the authentication processing unit 3013 performs processing for, when a user accesses the business chat service 301, causing the monitor 1041 of the user to display a login screen for receiving an input of user identification information such as a user ID or a password. Moreover, the authentication processing unit 3013, after transmitting the information input through the login screen to the authentication service 304, receives a result of authentication based on the transmitted information from the authentication service 304, and performs processing for switching the screen of the user and the like.

The plug-in management unit 3014 is a module for managing information regarding plug-ins that can be used in the business chat service 301. The plug-in management unit 3014 manages, for each user or group, plug-ins corresponding to the user or the group. When there are plug-ins held by a user and plug-ins held by a group to which the user belongs, for example, the plug-in management unit 3014 manages plug-ins that a user in the group is approved to use.

The storage unit 3015 is used for storing various types of information such as user information, group information, and meeting information. The plug-in group 3016 is a plug-in module group used in the business chat service 301. The plug-ins here include various plug-ins, in addition to plug-ins that are for basic functions such as a telephone function, a chat function, a meeting function, and a file management function. For example, the plug-ins may be a plug-in for editing a document and spread sheet data and a plug-in for accessing and managing a storage on a cloud. Also, the plug-ins may include a plug-in having a function as a viewer for reproducing a multimedia message including a video or a file in a format depending on a specific business operation such as CAD. Also, the plug-ins may be a plug-in having a function of creating a personal to-do list and a plug-in having a task management function of creating, assigning, and tracking a personal task and a task shared by a team. Also, the plug-ins may include another plug-in. In the present embodiment, a description will be given to the print plug-in 3017 for the computer 100 and the business chat service 301 to perform printing through the cloud printing service 305 while communicating with the external web server 302, among these functions.

Also, the plug-in used for executing the function may be a plug-in located in a store managed by the business chat service 301 or a plug-in for executing a function of service compatible with the business chat service 301. Also, the plug-in used for executing the function may be a plug-in that is uploaded from a local by a user and is shared between an individual and a team. In each module of the plug-in group 3016, an access destination in the web server 302 is defined, and when a plug-in is started, the business chat service 301 accesses a defined destination.

### (Functional Configuration of Web Server)

Next, an example of the functional configuration of the web server 302 will be described. The web server 302 includes a web page generation unit 3021, a process execution unit 3022, an acting processing unit 3023, and a storage unit 3024. The web server 302 provides a function of supporting printing of a file (e.g., a document file or an image file) that is transmitted and received through the business chat service 301, in cooperation with the print plug-in 3017.

The web page generation unit 3021 is a module for creating screen information regarding printing that the print plug-in 3017 displays, and providing the screen information to the business chat service 301. Here, a case is illustrated where the web page generation unit 3021 generates data that can be displayed by HTML and provides the data to the business chat service 301. The process execution unit 3022 is a module for performing control of a program that operates as JavaScript or Java servlet of the web server 302. For example, the process execution unit 3022 executes processing with respect to a request from a web page of the business chat service 301.

The acting processing unit 3023 is a module for performing processing on behalf of a user by obtaining an approval (permission or consent) from the user. For example, the acting processing unit 3023 accesses a file managed by a user, accesses an area of an external web service that only the user can refer to, and so on. The storage unit 3024 is a module for managing a storage or a database that retains information regarding a print job. The information regarding a print job includes web page data handled by the web server 302, information regarding display and setting for each user, data of a file to be printed that the web server 302 temporarily handles, print setting information, and the like.

### (Functional Configuration of Cloud Storage)

Next, an example of the functional configuration of the cloud storage 303 will be described. The cloud storage 303 includes a storage account management unit 3031, an access information management unit 3032, and a storage unit 3033. The cloud storage 303 provides a service for storing actual data of files and image data that are uploaded through the business chat service 301. In the present embodiment, a case is illustrated in which the business chat service 301 and the cloud storage 303 are managed with the same account, and in both of the services, authentication processing is performed using the authentication service 304.

The storage account management unit 3031 is a module for processing related to authentication of a user, when the user accesses the cloud storage 303, in cooperation with the authentication service 304. A configuration may also be adopted in which when the account is the same between the cloud storage 303 and the business chat service 301, once a user has logged in to a specific domain or a directory service, the user can collectively obtain the access rights. The access information management unit 3032 is a module that manages information regarding files uploaded to the business chat service 301 and the cloud storage 303.

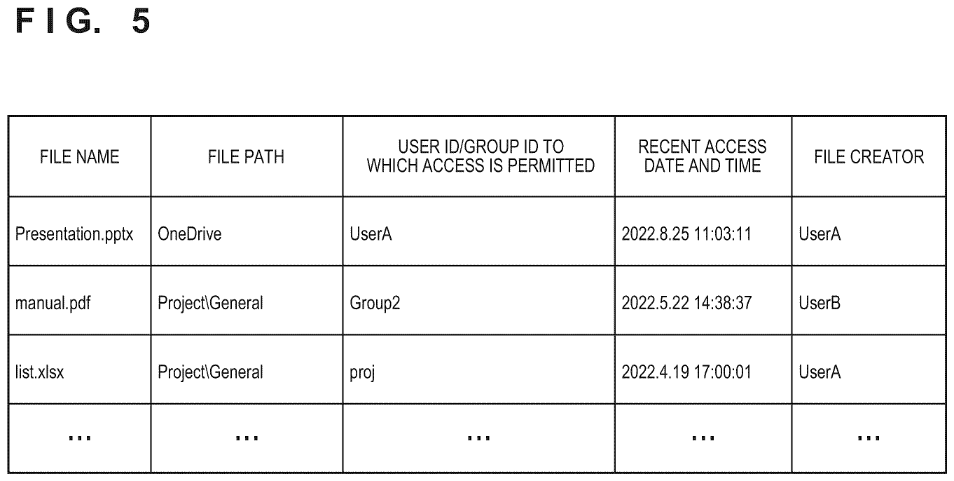

Here, an example of the file information managed by the access information management unit 3032 will be described with reference to FIG. 5. In the access information management unit 3032, the file information includes a file name, a file path, user IDs and group IDs that are permitted to access the file, recent access date and time, and information regarding a file creator. The “file name” is a file name of a file to be stored in the cloud storage 303. The “file path” indicates a placement location of the file, and is information for accessing the file. The “user IDs and group IDs that are permitted to access” is information for specifying users whose access to the file is approved. This information may be set by a user for each file, or may also be automatically set according to the location to which the file has been uploaded. In this setting, a plurality of settings may also be configured with respect to one file, that is, for respective file owners or for respective groups that the file owners belong, for example. Also, in this setting, information for designating to which level the same read/write authority is applied may also be set, in the case where this folder is of interest or the like. The storage unit 3033 is an area for storing a file substance.

### (Functional Configuration of Authentication Service)

Returning to the description of FIG. 3, an example of the configuration of the authentication service 304 will be described. The authentication service 304 includes an authentication processing unit 3041 and an authentication information management unit 3042. The authentication service 304 provides a service for performing processing to authenticate a user that uses the business chat service 301 and the cloud storage 303. The authentication service 304 performs authentication of a user that accesses the business chat service 301, the cloud storage 303, and the cloud printing service 305, and permits an access to each service depending on the authority. Accordingly, cooperation between services can be smoothly performed. Note that, here, in order to simplify the description, a case is assumed in which one authentication service is basically used, in common, in each service. However, the present invention is not limited to this, and the user authentication may be performed for each service, while switching the authentication services 304 of different types for the respective services, for example.

The authentication processing unit 3041 is a module for performing user authentication. The authentication method is not limited, and any authentication method may be used. For example, the authentication processing unit 3041 may perform user authentication using at least one authentication method among authentication using an ID and a password, face authentication, fingerprint authentication, and pattern authentication. The authentication information management unit 3042 is a module for managing information regarding user authentication. For example, the authentication information management unit 3042 manages a user affiliation (e.g., an organization or a group to which a user belongs). Also, the authentication information management unit 3042 manages authority given to a user, and assigns, to the user, an appropriate access right to a file or a storage corresponding to the authority. Also, the authentication information management unit 3042 may manage license information regarding a license that a user has purchased, and assign the right of usage based on the license information. For example, the authentication information management unit 3042 may assign the right of usage of software, a plug-in, or a service to a user, based on grade information regarding subscription that the user has purchased.

### (Functional Configuration of Cloud Printing Service)

Next, an example of the configuration of the cloud printing service 305 will be described. The cloud printing service 305 includes a printer management unit 3051, an account management unit 3052, and a print processing unit 3053. The cloud printing service 305 provides a service in which a file or image data is received from the computer 100, the web server 302, or the like, and print data is generated based on the received file or image data, and the print data is transmitted to the printer 200. The cloud printing service 305 may also receive print data generated in the computer 100 or a web browser, and transmits the print data to the printer 200.

The printer management unit 3051 is a module for performing processing to manage information regarding the printers 200, and to transmit the information in response to a request from a user or a group. For example, the printer management unit 3051 performs processing to transmit a list of printers 200 according to the scope manages by a user or group, in response to a request from the user or group. Also, the printer management unit 3051 manages capability information regarding the printers 200 (e.g., information regarding whether or not double-sided printing is possible, or whether or not color printing is possible), text information (e.g., manager's description and supplementary information), and position data (e.g., positioning information by GPS or address information). Also, the printer management unit 3051 performs processing for transmitting these pieces of information in response to a request from a user or group. Note that the information regarding the printers 200 managed by the printer management unit 3051 may be obtained from the printers 200, or may also be updated by manual editing performed by a user, for example.

The account management unit 3052 is a module for managing accounts for the printers 200. For example, the account management unit 3052 manages information indicating the managers of the printers 200 (e.g., which user or which group manages each printer). Also, the account management unit 3052 manages information indicating the sharers of the printers 200 (e.g., which user or which group shares each printer 200).

The print processing unit 3053 is a module for performing processing needed for printing in the printers 200. For example, the print processing unit 3053 performs, in addition to management of print settings and data conversion for each service, conversion to print data such as rendering of a file, as needed.

### <Print Processing>

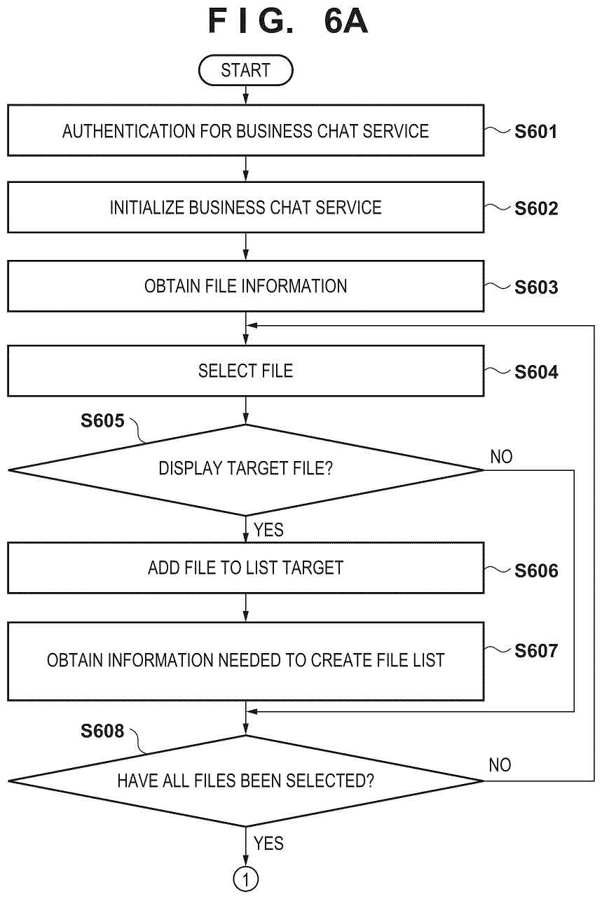

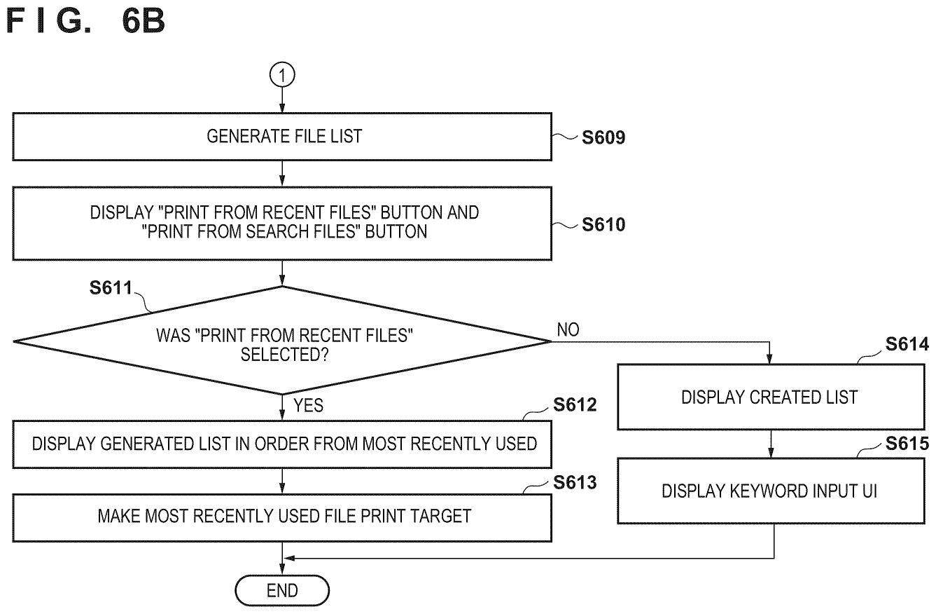

Next, the processing procedure in the information processing system when performing printing using the print plug-in 3017 according to the present embodiment will be described with reference to FIGS. 6A-6B. The processing described below is realized by a CPU of the web server 302, which is an information processing apparatus, reading out a program stored in a ROM or an auxiliary storage device to a RAM and executing the program. First, a user operates the button 402 for starting the print plug-in 3017 in the screen 400 of the business chat service 301 shown in FIG. 4, in order to start the print plug-in 3017. Then, the print plug-in 3017 is started, and the processing is started in the web server 302.

In step S601, the web server 302 performs authentication for the business chat service 301 via the authentication service 304, and receives an authentication result for the business chat service 301. Specifically, the web server 302 receives user information (e.g., user ID and password) of a user that has logged in the business chat service 301 from the business chat service 301. The web server 302 transmits the user information received from the business chat service 301 to the authentication service 304, and obtains an access token of the user. The access token is used for obtaining information regarding a print candidate file from the cloud storage 303 and obtaining a file designated by the user, for example.

Next, in step S602, the web server 302 initializes the business chat service 301. The web server 302 initializes an environment for the business chat service 301, and performs preparation for accessing a resource. Note that the initialization of the environment for the business chat service 301 may also be performed on a web page delivered from the web server 302. For example, the web server 302 obtains a user name, a user ID, a name or ID of a group to which the user belongs, an ID of a session or channel under connection, information regarding login and authority, locale information regarding a region or a language needed for displaying various types of information, and the like.

Next, in step S603, the web server 302 obtains information regarding a user accessible file using the business chat service 301 from the cloud storage 303. Specifically, the web server 302 obtains a predetermined number of files that the user who has logged in the business chat service 301 can access. The file information obtained here is not specifically limited as long as being a list of files that the user can access.

In the following steps S604 to S608, the web server 302 creates a list of print candidate files with respect to all of or a portion of the files obtained in step S603. First, in step S604, the web server 302 selects one file that is a selection target in this step from the files obtained in step S603. The files that are selection targets in step S604 may be all of the files obtained in step S603 or a portion of these files. The number of files that are selection targets is determined according to the number of files that can be included in the list to be displayed in the content area 403 shown in FIG. 4, for example. When it is envisioned that noise (e.g., a file that is not to be displayed in the list of print candidate files) is included in the files obtained in step S603, it is desirable that files of a number that is larger than an upper limit value of the number of files that can be included in the list are selected.

Note that there are cases where there is an upper limit to the number of files that can be obtained at once through WebAPI or the like (e.g., only 20 files can be obtained at once), and an ID or a link is present for obtaining the subsequent data at the last of the file obtaining result. In this case, the web server 302 obtains files using the ID or ling until a predetermined number is reached. Here, the web server 302 may obtain files using a different thread in background, which is different from the link generation processing.

Next, in step S605, the web server 302 determines whether or not the file selected in step S604 is a file that satisfies a condition as a file to be included in the list to be displayed in the content area 403 of the screen 400 of the business chat service 301. A specific example of determination as to whether or not the condition is satisfied will be described below.

For example, the web server 302 may determine whether or not the type of the file selected in step S604 is a type (file name extension or MIME Type) that is supported in the business chat service 301. Also, the web server 302 may determine whether or not the size of the file selected in step S604 satisfies a predetermined condition, for example. The web server 302 may also determine that at least one of a file whose size exceeds an upper limit value and a file whose size is below a lower limit value is not a file to be printed, for example. Also, the web server 302 may determine whether or not the file selected in step S604 is a file that satisfies a predetermined condition in which the type and size of a file are combined. In this case, the condition regarding a file size may be set for each file type (e.g., the size lower limit value for a text file may be smaller than the size lower limit value for a PDF file), for example. Also, the web server 302 may determine whether or not the file selected in step S604 is a printable file (e.g., whether or not being a file on which restriction regarding printing is imposed), for example. Specific examples of the determination condition in step S605 are described above, but the determination condition is not limited to the specific examples, and another alternative or additional determination condition may also be applied.

As a result of determination in step S605, if the file selected in step S604 is not a file that satisfies the condition as a file to be included in the list to be displayed in the content area 403 of the screen 400 of the business chat service 301, the processing is advanced to step S608. On the other hand, if the file selected in step S604 is a file that satisfies the condition as a file to be included in the list, the web server 302 adds the file to the files to be listed, in step S606.

Next, in step S607, the web server 302 obtains information needed to create the list of files selected in step S604. For example, when a list as shown in the content area 403 in the screen 400 of the business chat service 301 shown in FIG. 4 is to be created, the web server 302 obtains a file name, type, update date and time, and information regarding a storage location of the file selected in step S604. Note that the information needed to create the list of print candidate files is determined according to the information regarding a file to be displayed in the list. That is, the information obtained in step S607 is not limited to these pieces of information. For example, the information to be obtained in step S607 is a name or ID of a user or group, an outline of the file, or a name of a cloud storage in which the file is located. Also, when a thumbnail image or the like is included in the file information to be displayed in a list of print candidate files, the web server 302 obtains an image needed for display.

Next, in step S608, the web server 302 determines whether or not all of the files to be selected are selected in step S604. As a result of determination, if all of the files to be selected are not selected in step S604, the processing is returned to step S604. Therefore, the processing in steps S604 to S608 is repeatedly performed until it is determined, in step S608, that all of the files to be selected are selected. If all of the files to be selected are selected, the processing is advanced to step S609. In step S609, the web server 302 creates a file list to be displayed in the content area 403 in the screen 400 of the business chat service 301 based on the information obtained in step S607.

In the following steps S610 to S612, the web server 302 displays a UI for the user to select a file to be printed in the content area 403. In the present embodiment, as a method of displaying a generated file list, two methods, namely “files in order of recency of use” and “search by keyword”, will be described using FIG. 7. FIG. 7 illustrates a screen to be displayed in the monitor 1041 of the computer 100 used by the user. Note that a display method other than that described here may also be applied. First, in step S610, the web server 302 displays a button 701 “Print from Recent Files” and a button 702 “Print from Search Files”. The buttons 701 and 702 can be selected by user operation.

The function “Print from Recent Files” is a function of listing files that satisfy a condition regarding the time at which a file was accessed. That is, this is a method of displaying a list of files in the order of the time (timing) at which the file was lastly accessed. In this function, all of the files managed by the web server 302 may be listed, or files that have been accessed in a period from a predetermined time in the past until the current time may also be listed. Here, all users that are participating chats using the business chat service 301 may be the users that have accessed the print candidate files included in the list to be displayed in the area 700, for example. Alternatively, only the users that satisfy a specific condition among the users that are participating chats using the business chat service 301 may be the users that have accessed the print candidate files included in the list to be displayed in the area 700. The users that satisfy a specific condition are users that have logged in the business chat service 301, for example. Also, when users are participating a chat as a group, the users that have accessed the print candidate files included in the list to be displayed in the area 700 may be users of the group.

The period during which the print candidate files included in the list to be displayed in the area 700 have been accessed may include a period during which the business chat service 301 is used. Also, the period during which the print candidate files included in the list to be displayed in the area 700 have been accessed may also include a period prior to starting usage of the business chat service 301. The print candidate files included in the list to be displayed in the area 700 may also include files that are individually managed by individual users by themselves, regardless of whether or not the files are to be used when the business chat service 301 is used, for example. Note that the print candidate files included in the list to be displayed in the area 700 are desirably files managed in the cloud storage 303.

Also, in the list of print candidate files to be displayed in the area 700, pieces of file information are displayed in the order of the accessed time such that a file with a newer accessed time (close to the current time) is displayed in an upper row, for example. The information regarding a print candidate file to be displayed in the area 700 include information for allowing the user to recognize the file. In FIG. 7, a case is illustrated in which the file information includes “Type”, “Name”, “Modified”, and “Location”. “Type” indicates a file format. “Name” indicates a file name. “Modified” indicates date and time information at which a user who can access the file lastly accessed the file. “Modified” indicates date and time of last access, and therefore indicates date and time irrespective of whether or not the file content has been modified. Note that, in the present embodiment, “Modified” indicates the date and time at which a file has been accessed, but may indicate the date and time at which a file has been updated. “Location” indicates a file storage location.

In the present embodiment, a case is illustrated in which files that have been accessed by users who are participating chats using the business chat service 301 are extracted in a descending order of the accessed time, and the files are displayed in a list to be displayed in the area 700. Here, it is desirable that a condition is imposed on files to be extracted. Accordingly, a case is suppressed where files of a number that cannot be displayed in a list are extracted, or a file that is not to be printed is included in the list, for example. Note that, here, an example has been described in which files are displayed in a descending order of the accessed time downward from the upper portion of the list, but files may also be displayed in an ascending order of the accessed time downward from the upper portion of the list. Also, an object such as a button for switching the list display so as to change between the descending order and the ascending order may also be operably displayed.

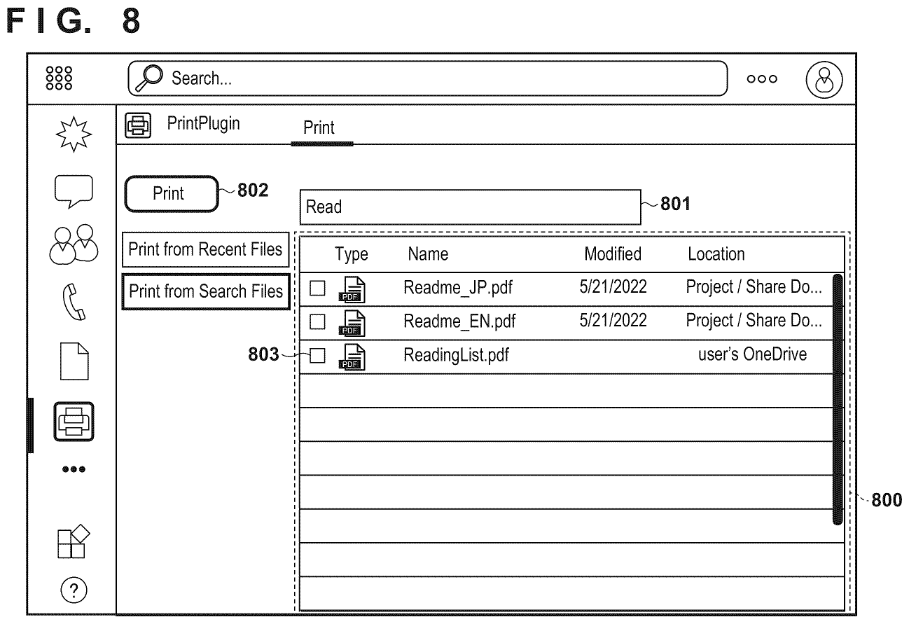

On the other hand, the function “Print from Search Files” is a method in which the file list generated in step S619 is searched using a keyword, and the result thereof is displayed as a list. Specifically, files in which the input keyword matches either a file name or content of the file are listed and displayed. Specifically, a mechanism is provided in which a keyword input UI as indicated by 801 in FIG. 8 is prepared, and when a user inputs a character string, a file that matches a keyword is retrieved from a list dynamically generated in step S619, and the retrieved files are displayed in the area 800. For example, if the user has input a keyword “Read”, only the files that include “Read” in the file name or content are listed.

Note that tabs “Type (file type)”, “Name (file name)”, “Modified (modified time)”, and “Location (storage location)”, which are pieces of file information, may be operably displayed (in uppermost portion of list display). When the user operates a given tab in this case, the display order of the list display may be switched in relation to this information. For example, switching may be performed such that, when “Type” is selected, files of the same “Type” are successively displayed in addition to the current display order. When “Name” is selected, sorting may be performed in alphabetical order or in Japanese alphabetical order. When “Modified” is selected, sorting may be performed in order of modified time. When “Location” is selected, sorting may be performed such that files of the same “Location” are successively displayed. In this way, control may be performed such that sorting is performed, as a list display order, so as to obtain a display order in which, in addition to a first condition (accessed time or searched files), a second condition (order of selected file information), which is a further different condition, is also considered. As described above, according to the present embodiment, the list display may be performed in a display order that satisfies one condition, or the list display may also be performed in a display order that satisfies a condition obtained by combining a plurality of conditions.

Also, in the print candidate file list displayed in the area 700 and area 800, check boxes for enabling the user to select a desired file are displayed along with pieces of file information. In the present embodiment, an example is illustrated in which information indicating whether or not a file has been selected is displayed based on whether the corresponding check box is checked. For example, FIG. 7 shows a case where “Test.pptx” has been selected as a file to be printed. In FIG. 7 in which files other than “Test.pptx” are not selected as files to be printed, a state in which one file has been selected is shown, but a plurality of files may also be selected as files to be printed.

Return to the description of FIGS. 6A-6B. The web server 302 displays a button for enabling switching between the above display methods (of the first condition), and advances the processing to the next step. Note that, in the present embodiment, two options are described as the first condition, but the present invention is not limited to this, and other alternative or additional options may also be provided. For example, when “importance” is added as information regarding the file attribute, a condition according to the importance or a condition described as the second condition may also be applied as the first condition for creating the list. In step S611, the web server 302 determines whether the currently selected display method is “Print from Recent Files” or not. If “Print from Recent Files” is determined, the processing is advanced to step S612, and if not, that is, if “Print from Search Files” is determined, the processing is advanced to step S614.

In step S612, the web server 302 displays the created list in descending order of use time in the area 700, and advances the processing to the next step. In step S613, the web server 302 selects a most recently-used file, that is, the file displayed in the uppermost row as the file to be printed, and ends the processing of this flowchart. That is, considering that a user desires to print a recently-used file, display is made in a state in which the most recently-used file is selected as the file to be printed. For example, regarding the file that is displayed in the uppermost row when the files are arranged in descending order of use time, in the “Modified” column, “JustNow” is displayed, as shown in FIG. 7, which indicates that the file has been opened up to just now. If it is assumed that the user has operated the button 402 for starting the print plug-in 3017 at this timing, it can be envisioned that the user has called the print plug-in 3017 in order to print the file that has been opened up to right now. Therefore, in the present embodiment, processing is performed such that the most recently-used file is the file to be printed. Then, the processing is advanced to step S616, and the processing for performing display in the area 700 of the web server 302 is ended.

On the other hand, if “Print from Search Files” is determined in step S611, in step S614, the web server 302 displays the file list generated in step S609. In this case, any order may be adopted regarding the order of items displayed in the area 800. This is because, as a result of performing keyword input in the next step, the area 800 is updated. Next, in step S615, the web server 302 displays a keyword input UI for allowing the user to perform input, and ends the processing of this flowchart. For example, in FIG. 8, a file list obtained when a keyword “Read” has been input is displayed, but a file that the user has never accessed is included as indicated by the fact that the item “Modified” of the file 803 is blank. In this case, this file is a file that is never to be displayed in the display method “Print from Recent Files” described above. Therefore, as a result of providing two display method (only the first condition) to users, as in the present embodiment, a file that cannot be selected as a file to be printed can be selected using another display method.

With the display method described above, the user can find a file to be printed, and the file to be printed can be appropriately selected. Thereafter, the user selects a file to be printed, and operates the button 704 or 802, and with this, printing can be performed in the printer 200 via the connected cloud printing service 305.

Also, in the present embodiment, a list generated in step S619 is used in the two display methods described above, and list display is performed according to the adopted display method. However, when a list is generated in step S619, the list may be generated by adopting the display method “files in order of recency of use”. Alternatively, a configuration may also be adopted in which files containing a keyword input by the user are inquired about with the access information management unit 3032 of the cloud storage, the corresponding files are obtained, and thereafter, the file list is generated.

As described above, the information processing apparatus according to the present embodiment manages files to be printed that can be accessed from a plurality of apparatuses via a network. Also, in response to a request from any of the plurality of apparatuses, this information processing apparatus creates a list of one or more files to be printed, based on a first condition included in the request, and causes the apparatus that has made the request to display the list. The first condition is a condition selected from a plurality of conditions by a user operation performed on the apparatus that has made the request. The plurality of conditions that can be selected as the first condition include a condition regarding a time at which the file to be printed was accessed, and a condition that a designated keyword is contained in a file. Accordingly, the user can browse a list obtained by narrowing down a plurality of managed files by selecting a desired condition, and can easily find a desired file. As described above, according to the present embodiment, retrieving of a desired file to be printed by a user can be suitably supported.

### Modifications

The present invention is not limited to the embodiment described above, and various modification are possible. For example, when “Print from Search Files” is selected, there are cases where, only by keyword search, the number of items to be displayed is too large to be displayed in the area 800. Therefore, in addition to the display method of the embodiment described above, a display method may also be provided with which more accurate search result can be obtained by performing filtering using a group.

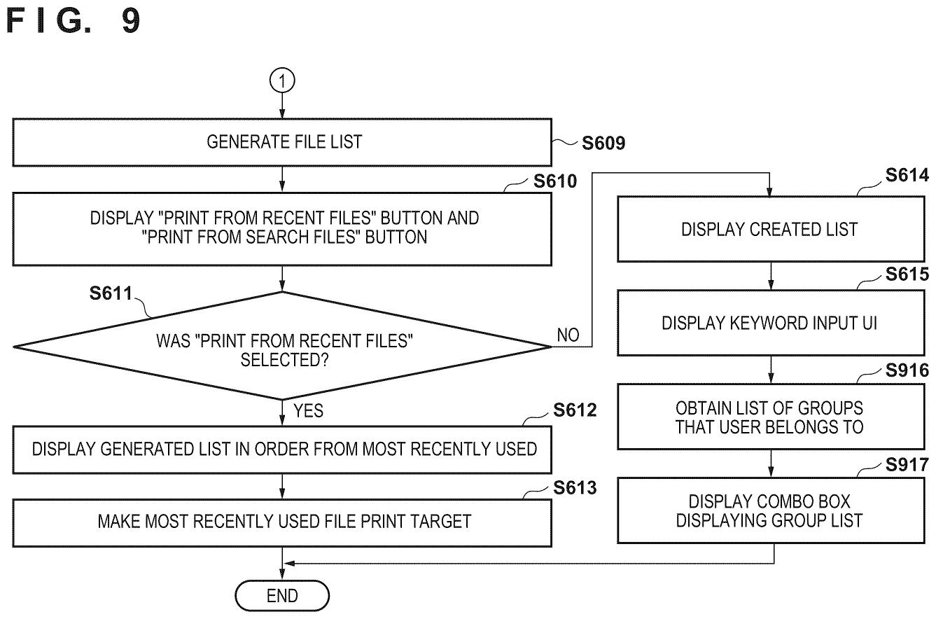

The filtering processing using a group according to the modification will be described with reference to FIG. 9. The processing described below can be realized by the CPU of the web server 302, which is an information processing apparatus, reading out a program stored in a ROM or an auxiliary storage device to a RAM, and executing the program. The processing from step S600 to step S615 is similar to the processing in the flowchart in FIGS. 6A-6B according to the embodiment described above, and therefore the same step numbers are given, and the description thereof will be omitted. After step S615, the processing is advanced to step S916.

In step S916, the web server 302 obtains a list of groups to which users belong from the group information management unit 3012. Next, in step S917, the web server 302 displays the groups as a pull-down UI with which a target group can be selected such that a user can perform filtering for the search target, and thereafter ends the processing of this flowchart.

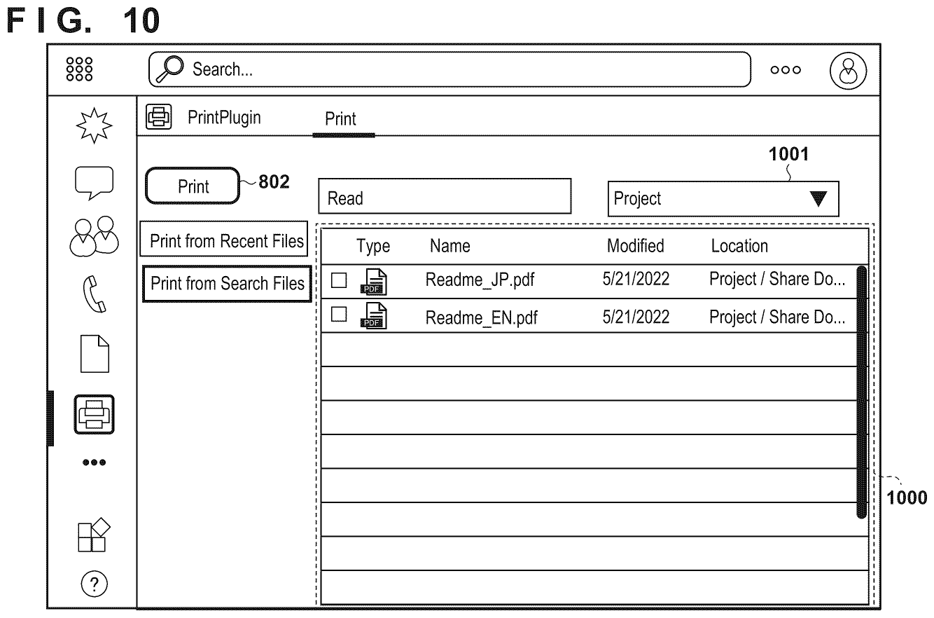

FIG. 10 shows an example of the UI displayed in step S917. A pull-down 1001 is a pull-down for selecting a specific group from the groups to which a logged-in user participates. In the example in FIG. 10, “Project” is selected. As a result of selecting a group in this pull-down 1001, the search range of files whose file name includes a keyword that has been input through the keyword input UI is limited to the selected group. That is, when “Project” is selected and “Read” has been input to the keyword input UI, files that include “Read” in their file names or file contents are retrieved from the files that are stored in association with the “Project” group. As a result of reducing the search target range in this way, the time taken for search can be reduced. Also, when files having the same name are stored in association with a plurality of groups, the user can easily identify a desired file. According to this modification, more accurate search can be performed.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139125, filed Aug. 29, 2023 which is hereby incorporated by reference herein in its entirety.

What is claimed is:

1. An information processing apparatus comprising
one or more memory devices that store a set of instructions; and
one or more processors that execute the set of instructions to:
manage files to be printed that are accessible from a plurality of apparatuses via a network, and
make, in response to a request from any one of the plurality of apparatuses, a list of one or more of the files to be printed based on a first condition included in the request, and cause the one apparatus that has made the request to display the list,
wherein the first condition is a condition selected from a plurality of conditions by a user operation in the one apparatus that has made the request.

2. The information processing apparatus according to claim 1, wherein
the plurality of conditions that can be selected as the first condition at least includes a condition regarding a time at which the file to be printed was accessed, and a condition that a designated keyword is included in the file.

3. The information processing apparatus according to claim 2, wherein
the one or more processors execute instructions in the one or more memory devices to:
in a case where the condition regarding a time at which the file to be printed was accessed is selected, create a list including files that have been accessed in a period from a past predetermined time to a current time.

4. The information processing apparatus according to claim 2, wherein
the one or more processors execute instructions in the one or more memory devices to:
in a case where the condition regarding a time at which the file to be printed was accessed is selected, create a list of all files that are managed in descending order of the time at which each file was accessed.

5. The information processing apparatus according to claim 2, wherein
the one or more processors execute instructions in the one or more memory devices to:
in a case where the condition that a designated keyword is included in the file is selected, create a list that includes files including the designated keyword in their file names or file contents.

6. The information processing apparatus according to claim 1, wherein
the one or more processors execute instructions in the one or more memory devices to:
in a case where the request includes information regarding a group, create a list based on the first condition in a range of the files to be printed related to the group.

7. The information processing apparatus according to claim 6, wherein
the one or more processors execute instructions in the one or more memory devices to:
every time the first condition is selected according to a user operation, in an apparatus that has made the request, provide a list in which one or more of the files to be printed are newly included to the apparatus.

8. The information processing apparatus according to claim 6, wherein
the one or more processors execute instructions in the one or more memory devices to:
in a case where a second condition different from the first condition is included in the request separately from the first condition, provide a list in which one or more of the files to be printed that were listed according to the first condition are sorted according to the second condition, to an apparatus that has made the request.

9. The information processing apparatus according to claim 8, wherein
the second condition corresponds to any of pieces of information included in a file displayed in an apparatus that has made the request.

10. The information processing apparatus according to claim 9, wherein
the pieces of information included in a file displayed in an apparatus that has made the request at least includes one of a file type, file name, file modified time, and file storage location.

11. The information processing apparatus according to claim 6, wherein
in a case where a print plug-in is started through a chat service that operates in an apparatus that has made the request, the information processing apparatus starts processing.

12. A control method of an information processing apparatus, comprising:
managing files to be printed that are accessible from a plurality of apparatuses via a network, and
making, in response to a request from any one of the plurality of apparatuses, a list of one or more of the files to be printed based on a first condition included in the request, and causing the one apparatus that has made the request to display the list,
wherein the first condition is a condition selected from a plurality of conditions by a user operation in the one apparatus that has made the request.

13. A non-transitory computer-readable storage medium storing a computer program for causing a computer to execute the steps in a control method of an information processing apparatus, the control method comprising:
managing files to be printed that are accessible from a plurality of apparatuses via a network, and
making, in response to a request from any one of the plurality of apparatuses, a list of one or more of the files to be printed based on a first condition included in the request, and causing the one apparatus that has made the request to display the list,
wherein the first condition is a condition selected from a plurality of conditions by a user operation in the one apparatus that has made the request.

14. The non-transitory computer-readable storage medium according to claim 13, wherein
the plurality of conditions that can be selected as the first condition at least includes a condition regarding a time at which the file to be printed was accessed, and a condition that a designated keyword is included in the file.

15. The non-transitory computer-readable storage medium according to claim 14, wherein
the causing to display the list includes, in a case where the condition regarding a time at which the file to be printed was accessed is selected, creating a list including files that have been accessed in a period from a past predetermined time to a current time.

16. The non-transitory computer-readable storage medium according to claim 14, wherein
the causing to display the list includes, in a case where the condition regarding a time at which the file to be printed was accessed is selected, creating a list of all files that are managed in descending order of the time at which each file was accessed.

17. The non-transitory computer-readable storage medium according to claim 14, wherein
the causing to display the list includes, in a case where the condition that a designated keyword is included in the file is selected, creating a list that includes files including the designated keyword in their file names or file contents.

18. The non-transitory computer-readable storage medium according to claim 13, wherein
the causing to display the list includes, in a case where the request includes information regarding a group, creating a list based on the first condition in a range of the files to be printed related to the group.

19. The non-transitory computer-readable storage medium according to claim 18, wherein
the causing to display the list includes, every time the first condition is selected according to a user operation, in an apparatus that has made the request, providing a list in which one or more of the files to be printed are newly included to the apparatus.

20. The non-transitory computer-readable storage medium according to claim 18, wherein
the causing to display the list includes, in a case where a second condition different from the first condition is included in the request separately from the first condition, providing a list in which one or more of the files to be printed that were listed according to the first condition are sorted according to the second condition, to an apparatus that has made the request.

21. The non-transitory computer-readable storage medium according to claim 20, wherein
the second condition corresponds to any of pieces of information included in a file displayed in an apparatus that has made the request.

22. The non-transitory computer-readable storage medium according to claim 21, wherein
the pieces of information included in a file displayed in an apparatus that has made the request at least includes one of a file type, file name, file modified time, and file storage location.

23. The non-transitory computer-readable storage medium according to claim 18, wherein
in a case where a print plug-in is started through a chat service that operates in an apparatus that has made the request, the information processing apparatus starts processing.
